(19) United States
(12) Patent Application Publication
(10) Pub. No.: US 2001/0040309 A1
(43) Pub. Date: Nov. 15, 2001

(54) METHOD OF FORMING AIR VENT HOLES OF A REAR CASE FOR AN LCD MONITOR, AND AN APPARATUS THEREFOR

(76) Inventor: YOU-SIK HONG, SUWON (KR)

Correspondence Address: STAAS & HALSEY LLP, 700 11TH STREET, NW, SUITE 500, WASHINGTON, DC, 20001, US

(21) Appl. No.: 09/186,148

(22) Filed: Nov. 5, 1998

(30) Foreign Application Priority Data
Nov. 6, 1997 (KR) 97-58460

(51) Int. Cl. B29C 33/76; B29C 45/36

(52) U.S. Cl. 264/219; 249/64; 249/151; 264/328.1; 264/328.9; 425/577

(57) ABSTRACT

A method of forming a number of air vent holes in a rear case of a liquid crystal flat plate display (LCD) monitor and an apparatus therefor. The method includes forming a number of air vent holes on an incline plane of the rear case using a first metal mold and a second metal mold, such that pin holes are formed in the first metal mold and protrusion pins are installed in the second mold so as to be respectively inserted into the pin holes, to form respective air vent holes. The molding is performed in a state that the protrusion pins are inserted into the respective pin holes during injection of a solution which forms the rear case.

### CROSS-REFERENCE TO RELATED APPLICATIONS

This application makes reference to, incorporates the same herein, and claims all benefits accruing under 35 U.S.C. §119 from the application entitled Air Vent Hole of Rear Case for LCD Monitor Form Method filed with the Korean Industrial Property Office on Nov. 6, 1997 and duly assigned Ser. No. 97-58460 by that Office.

### BACKGROUND OF THE INVENTION

1. Field of the Invention

The present invention relates to a method of forming a number of air vent holes in a rear case of a liquid crystal flat plate display monitor and an apparatus therefor, and more particularly, to a method of forming a number of air vent holes for a rear case of an LCD monitor so as to improve the smoothness and produce a better molding in forming a number of air vent holes in the rear case, and an apparatus therefor.

2. Discussion of the Related Art

Generally, a liquid crystal flat plate display monitor (hereafter abbreviated to LCD monitor) has a liquid crystal flat plate 1 installed on a front case 2 and a rear case 3 as illustrated in FIG. 1A and FIG. 1B and the rear case 3 has a back forming an incline plane 3a.

The reasons for such a configuration are for design purposes and that in boring air vent holes for releasing out heat generated from an inner part of the LCD monitor, the air vent holes are designed to be located as near as possible to a circuit plate (not illustrated) installed in the inside of the LCD monitor.

Consequently, the rear case 3 has a structure, in which a number of air vent holes 4 are formed on the incline plate 3a.

On that account, as shown in FIGS. 2 and 3, a first metal mold 5 and a second metal mold 5′ are used in a conventional mold method. FIG. 3 is a magnified cross-sectional view of part “A” of FIG. 2. In the conventional mold method, molding through forming a number of pin protrusions protruding in the second metal mold 5′ has been carried out in an injection molding of the rear case 3 between the first and second metal molds 5, 5′ in order to form the air vent holes 4 in the rear case 3.

However, a negative point of the conventional mold method described above is that an end part of a pin protrusion 6 does not exactly coincide with a surface of the first metal mold 5 due to a metal mold allowance and an operation allowance of an injector, etc.

That is, when the end part of the pin protrusion 6 of the second metal mold 5′ does not contact the first metal mold 5 and the rear case 3 is molded in a state that a gap occurs, then as an injection solution penetrates into the gap and is molded in the state that the air vent hole gets plugged or partly plugged, inferior goods (rear case 3) are produced.

In addition, as the pin protrusion 6 is in contact with the surface of the first metal mold 5, abrasion occurs and a gap in an amount of an abrasion ratio occurs. Accordingly, the above-mentioned same problem relating to the gap is brought about and at this time the first and second metal molds 5, 5′ must be uneconomically exchanged.

When the end part of the pin protrusion 6 of the second metal mold 5′ strongly contacts the surface of the first metal mold 5, a shock power F acts in every direction, as illustrated in FIG. 4. Thus, a negative effect due to abnormal stress follows not only on the metal molds themselves, but also on the injector. Accordingly, it becomes a source of trouble and defects, and so the productivity of the LCD monitor falls.

### SUMMARY OF THE INVENTION

Accordingly, to overcome the drawbacks in the conventional art, it is therefore an object of the present invention to promote a smooth molding in molding air vent holes formed in a rear case of an LCD monitor.

Additional objects and advantages of the invention will be set forth in part in the description which follows and, in part, will be obvious from the description, or may be learned by practice of the invention.

To achieve the above and other objects of the present invention, a molding method is provided which includes molding a rear case having air vent holes in a way that a protrusion pin is molded by passing through between the first metal mold and the second metal mold.

To achieve the above and other objects and in accordance with the purpose of the present invention, as embodied and broadly described, there is provided a method of forming a number of air vent holes for a rear case of an LCD monitor including forming a number of air vent holes on an incline plane of the rear case molded by first and second metal molds. By forming pin holes in the first metal mold and respectively installing protrusion pins in the second mold so as to be inserted into the pin holes, the molding is performed in a state that the protrusion pins are inserted into the respective pin holes at the injecting step of the molding method.

### BRIEF DESCRIPTION OF THE ATTACHED DRAWINGS

A more complete appreciation of the invention, and many of the attendant advantages thereof, will be readily apparent as the same becomes better understood by reference to the following detailed description when considered in conjunction with the accompanying drawings in which like reference symbols represent the same or similar components, wherein:

FIG. 1A and FIG. 1B are perspective views illustrating a front side and a rear side of a conventional LCD monitor;

FIG. 2 is a vertical cross-sectional view explaining a conventional molding method of forming air vent holes in a rear case of the LCD monitor shown in FIGS. 1A and 1B;

FIG. 3 is a magnified cross-sectional view of part “A” of FIG. 2;

FIG. 4 is a cross-sectional view explaining a problem of the conventional molding method;

FIG. 5 is a vertical cross-sectional view explaining a molding method according to an embodiment of the present invention;

FIG. 6 is a magnified cross-sectional view of part “B” of FIG. 5; and

FIG. 7 is a cross-sectional view illustrating air vent holes in a finished state of the molding method according to the embodiment of the present invention.

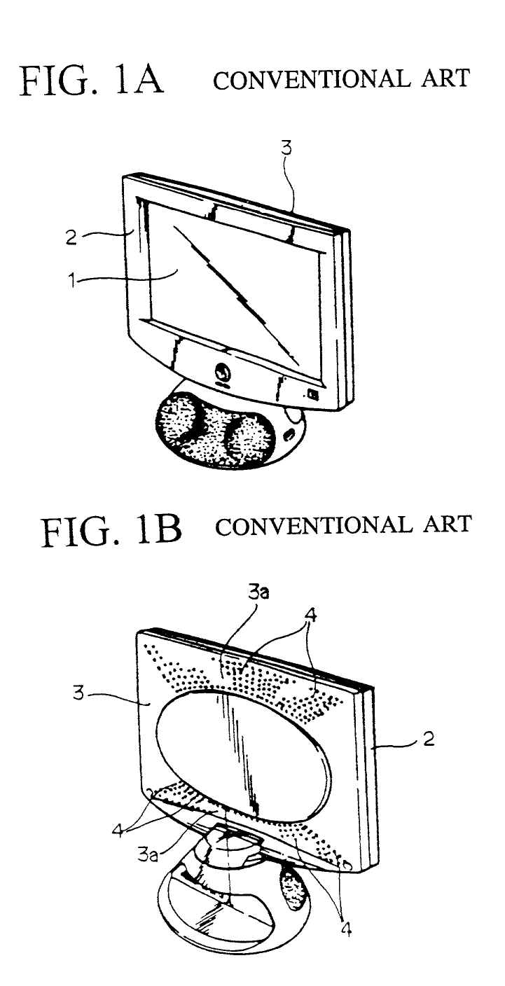

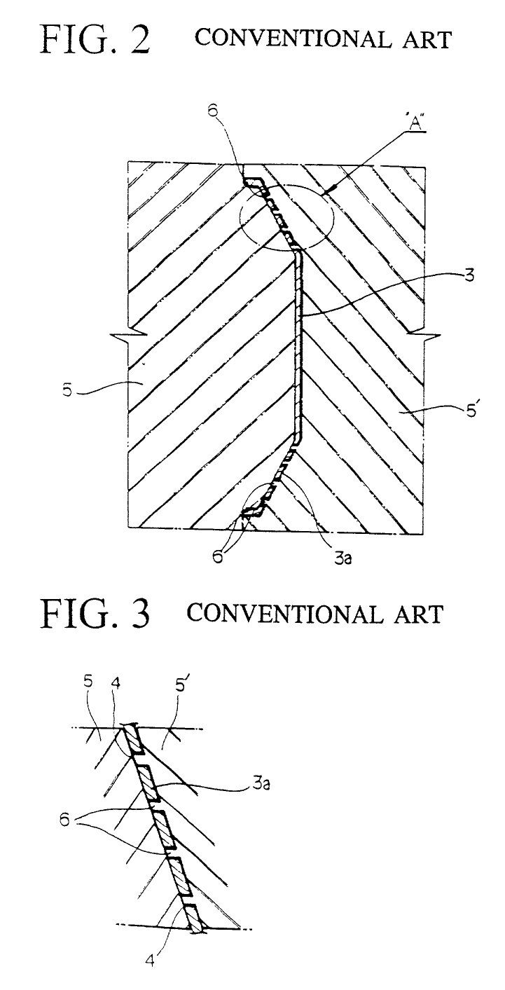

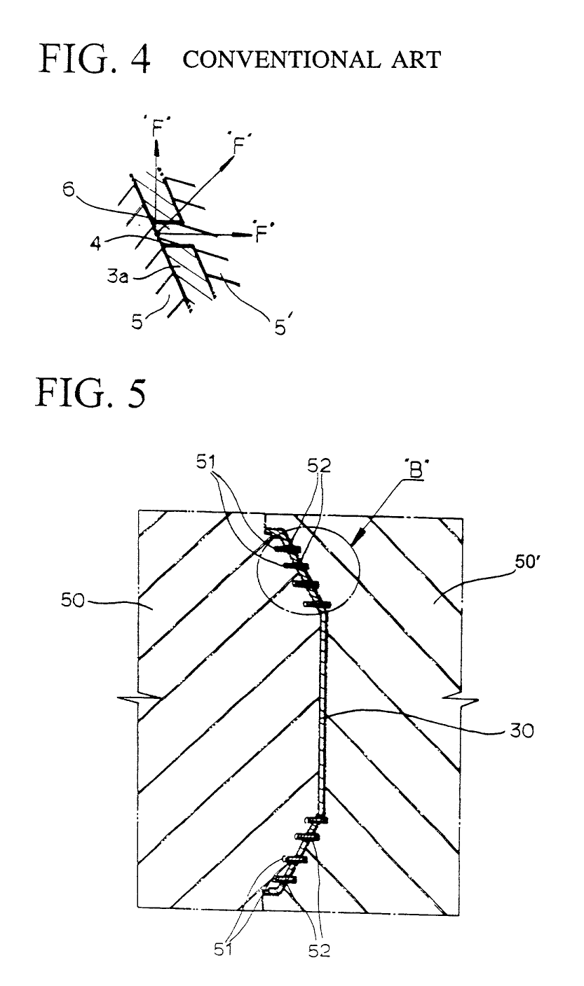

### DETAILED DESCRIPTION OF PREFERRED EMBODIMENT

It will be apparent to those skilled in the art that various modifications can be made in the method of forming air vent holes in a rear case for an LCD monitor according to the present invention, without departing from the spirit of the invention. Thus, it is intended that the present invention covers such modifications as well as variations thereof, within the scope of the appended claims and their equivalents.

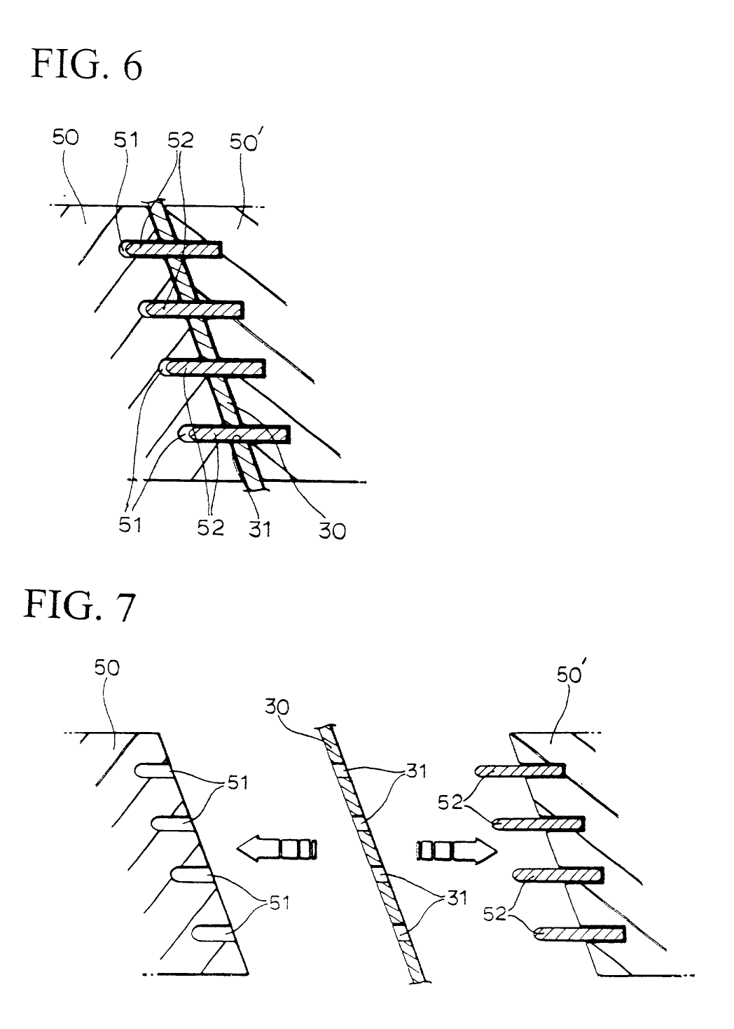

FIG. 5 through FIG. 7 illustrate a method of molding air vent holes in the rear case of an LCD monitor according to an embodiment of the present invention, and there are provided a first metal mold 50 and a second method mold 50′ for molding a rear case 30. FIG. 5 is a vertical cross-sectional view of the molding method according to the embodiment of the present invention, whereas FIG. 5 is a magnified cross-sectional view of part “B” of FIG. 5. FIG. 7 is a cross-sectional view illustrating air vent holes in a finished state of the molding method according to the embodiment of the present invention.

In order to mold a number of air vent holes being formed in the rear case 30, a number of pin holes 51 are formed in the first metal mold 50 and protrusion pins 52 to be inserted into or separated from the pin holes 51 are installed protruding from the second metal mold 50′.

Accordingly, as the first and second metal molds 50, 50′, in a state loaded on an injector (not shown), are moved to a state in which they are adhered closely with each other, the protrusion pins 52 of the second metal mold 50′ become inserted into the pin holes 51 of the first metal mold 50.

At this time, in order to prevent an abnormal stress from happening in the first and second metal mold 50, 50′ due to the end parts of the protrusion pins 52 being in contact with the inner part of the respective pin holes 51, the pin holes 51 are made to have deeper depth than the protruded height of the protrusion pins 52.

Therefore, as the first and second metal molds 50, 50′ become adhered closely with each other for molding, the end parts of the protrusion pins 52 are made not to be in contact with the pin holes 51 when the protrusion pins 52 are inserted into the pin holes 51.

In this state, the rear case 30 is molded by filling a gap formed between the first and second metal molds 50, 50′ with injected substances (solutions). Here, as the parts of the protrusion pins 51 are not filled up with the injected substances (the solutions), the first and second metal molds 50, 50′ are separated and the regions in which there were the protrusion pins 52 become air vent holes 31.

FIG. 7 illustrates the state, in which the first and second metal molds 50, 50′ are separated when the injection molding as explained above has finished. When the metal molds are separated, the molding is performed so that the air vent holes 31 are formed in the place in which there were the protrusion pins 52, as the protrusion pins 52 are separated from the pin holes 51 and come out from the rear case 30.

As described above, the present invention enables the air vent holes of the rear case to be molded. Furthermore, as the protrusion pins of the second metal mold for molding the air vent holes do not come into contact (do not collide) with the first metal mold, abnormal stress is not applied to any portion of the first and second metal molds. Therefore, the present invention also offers the effect of preventing damage to the first and second metal molds.

In addition, as the protrusion pins for forming the air vent holes are entirely inserted into the pin holes, the air vent holes are completely molded even though abrasion of the first and second metal molds occurs. Therefore, the present invention offers the effect to be able to mold complete air vent holes, without any material plugging or partially plugging the air vent holes.

What is claimed is:

1. A method of forming air vent holes in an incline plane of a rear case of a monitor, comprising the steps of:
forming pin holes in a first incline surface of a first mold;
forming protrusion pins on a second incline surface of a second mold, wherein the second incline surface corresponds to the first incline surface and the protrusion pins respectively correspond to the pin holes;
moving the first and second molds toward each other into an injection position so that the protrusion pins are respectively inserted into the pin holes, and a gap is formed between the first and second molds other than at the pin holes and protrusion pins; and
injecting a solution which forms the rear case into the gap while the first and second molds are in the injection position.

2. The method as claimed in claim 1, wherein a depth of the pin holes is greater than a depth of the respective protrusion pins.

3. The method as claimed in claim 1, wherein the step of moving the first and second molds toward each other comprises the step of having sides of the protrusion pins contact sides of the respective pin holes when the first and second molds are in the injection position, to prevent the solution from entering the pin holes.

4. The method as claimed in claim 2, wherein the step of moving the first and second molds toward each other comprises the step of having sides of the protrusion pins contact sides of the respective pin holes when the first and second molds are in the injection position, to prevent the solution from entering the pin holes.

5. A method of forming air vent holes in a case of a monitor, comprising the steps of:
placing a first mold, which has a first surface in which pin holes are formed, and a second mold, which has a second surface in which protrusion pins are formed, relative to each other to be in an injection position, so that a gap is formed between the first and second surfaces and the projection pins become respectively inserted into the pin holes;
injecting a solution into the gap, and forming the rear case from the solution, wherein the air vent holes are formed at positions where the projection pins are located within the gap; and
separating the first and second molds from each other.

6. The method as claimed in claim 5, wherein a depth of the pin holes is greater than a depth of the respective protrusion pins when the first and second molds are in the injection position, so that end parts of the protrusion pins do not contact ends of the respective pin holes when the first and second molds are in the injection position.

7. The method as claimed in claim 5, wherein sides of the protrusion pins contact sides of the respective pin holes when the first and second molds are in the injection position, to prevent the solution from entering the pin holes during the injecting of the solution step.

8. The method as claimed in claim 6, wherein sides of the protrusion pins contact sides of the respective pin holes when the first and second molds are in the injection position, to prevent the solution from entering the pin holes during the injecting of the solution step.

9. The method as claimed in claim 5, wherein the p in holes are oblique to the first surface and the protrusion pins are oblique to the second surface.

10. The method as claimed 5, wherein the step of placing the first and second molds relative to each other to be in an injection position comprises the step of adhering the first and second molds to each other.

11. A mold for forming air vent holes in a case of a monitor comprising:
a first mold having a first surface in which pin holes are formed; and
a second mold, which has a second surface in which protrusion pins are formed, relatives to each other;
wherein a gap in a shape of the case is formed between the first and second surfaces and the projection pins respectively insert into the pin holes so that the protrusion pins extend through the gap, when the first and second molds are placed in a predetermined position relative to each other.

12. The mold as claimed in claim 11, wherein:
the pin holes are oblique to the first surface; and
the protrusion pins are oblique to the second surface.

13. The mold as claimed in claim 11, wherein the pin holes have a depth greater than the respective protrusion pins.

14. The mold as claimed in claim 11, wherein sides of the protrusion pins contact sides of the respective pin holes when the first and second molds are placed in the predetermined position relative to each other.

15. The mold as claimed in claim 13, wherein sides of the protrusion pins contact sides of the respective pin holes when the first and second molds are placed in the predetermined position relative to each other, so that enclosed spaces are formed at respective end portions of the pin holes.

16. The mold as claimed in claim 11, wherein:
the first mold has a third surface oblique and adjacent to the first surface and a fourth surface oblique and adjacent to the third surface; and
the second mold has a fifth surface oblique and adjacent to the second surface and a sixth surface oblique and adjacent to the fifth surface;
wherein
the fourth surface has additional pin holes formed therein and the sixth surface has additional protrusion pins formed thereon, and
the gap in the shape of the case is formed by the first through sixth surfaces and the additional projection pins respectively insert into the additional pin holes so that the additional protrusion pins extend through the gap, when the first and second molds are placed in the predetermined position relative to each other.

17. The mold as claimed in claim 11, wherein the first and second molds are made of metal.
